(19) United States
(12) Patent Application Publication
(10) Pub. No.: US 2002/0000483 A1
(43) Pub. Date: Jan. 3, 2002

(54) FUEL INJECTOR NOZZLE

(76) Inventors: TAKESHI SHOJI, KANAGAWA (JP); YOSHINORI IWABUCHI, KANAGAWA (JP); HIROSHI INO, KANAGAWA (JP)

Correspondence Address: ROSSI & ASSOCIATES, P O BOX 826, ASHBURN, VA, 201460826

(21) Appl. No.: 09/225,163

(22) Filed: Jan. 4, 1999

(30) Foreign Application Priority Data
Jun. 11, 1998 (JP) HEI 10-163591
Jan. 6, 1998 (JP) HEI 10-000793

(51) Int. Cl. F02M 61/00

(52) U.S. Cl. 239/533.2; 239/533.3

(57) ABSTRACT

A fuel injector nozzle is provided which includes an injector nozzle body having a distal end portion in which a plurality of pairs of injection holes are formed, such that each pair of injection holes are spaced from each other in an axial direction of the nozzle body, and such that injection axes of each pair of injection holes intersect with each other at a point outside of the nozzle body. According to the present invention, jets of fuel that are ejected from each pair of injection holes collide with each other immediately after passing through exits of the injection holes, such that a crossed axes angle θ formed by the injection axes of each pair of injection holes is in a range of 30°≦θ≦80°.

### FIELD OF THE INVENTION

The present invention relates to a fuel injector nozzle adapted to inject fuel into a combustion chamber of an internal combustion engine, such as a diesel engine.

### BACKGROUND OF THE INVENTION

In a diesel engine, for example, a fuel injector nozzle is provided in a cylinder head for each cylinder, and high-pressure fuel is injected from the fuel injector nozzle into each of combustion chambers of the engine.

In most cases, the fuel injector nozzle of the above type injects the fuel from a plurality of openings or outlets formed therein, without causing collision of fuel jets ejected from the respective openings.

In the meantime, the fuel that is injected into the combustion chamber is preferably kept from adhering to walls of the combustion chamber (including the lower surface of the cylinder head). Also, the fuel is desirably in the form of fuel spray or mist that is well mixed with the air in the combustion chamber, to provide an air/fuel mixture to be burned in the chamber.

To form the fuel into fuel spray or mist, the fuel emitted from the fuel injector nozzle is required to have sufficiently small spray penetration and sufficiently small particle size, and also required to spread uniformly within the combustion chamber. If the fuel injector nozzle has a single opening or hole through which the fuel is injected, it is difficult for such a nozzle to satisfy these requirements.

In a known example of fuel injector nozzle as disclosed in Japanese laid-open Patent Publication No. 7-310628, a pair of injection holes are provided on the side of a distal end of a nozzle body, such that these injection holes are spaced from each other in the axial direction of the nozzle body, and such that injection axes of these injection holes intersect with each other with a small angle formed therebetween. In operation, fuel jets ejected from the respective injection holes are caused to collide with each other at a point outside the nozzle body, so as to form a fuel spray.

In the fuel injector nozzle disclosed in the above-identified publication, however, the injection axes of the pair of injection holes form a small angle (crossed axes angle) with which they intersect with each other, and therefore the resulting fuel spray has excessively large spray penetration, and a small angle of expansion (spray angle). Also, the fuel in the spray thus produced is unlikely to undergo atomization and has an undesirably large particle size.

To solve the above problems, the crossed axes angle of the injection axes may be changed. By merely changing the crossed axes angle of the injection axes, however, only the spray penetration may be reduced, or only the spray angle (angle of expansion of the spray) may be increased, or only the particle size of the fuel spray may be reduced. It is thus difficult to form fuel spray having all of the optimum characteristics.

It has been desired, therefore, to provide a fuel injector nozzle that is able to produce fuel spray having reduced spray penetration, increased spray angle, and reduced particle size at the same time.

### SUMMARY OF THE INVENTION

The present invention has been developed in the light of the above situations. It is therefore the first object of the invention to provide a fuel injector nozzle that produces fuel spray having reduced spray penetration, and a reduced particle size due to improved atomization, while permitting the fuel to be uniformly dispersed in the combustion chamber.

The second object of the invention is to provide a fuel injection nozzle that produces fuel spray suitable for compression-ignition type premixed combustion, assuring reduced spray penetration, and a reduced particle size due to improved atomization, while permitting the fuel to be uniformly dispersed in the combustion chamber.

To accomplish the first object, the present invention provides a fuel injector nozzle including an injector nozzle body having a distal end portion in which a plurality of pairs of injection holes are formed, such that each pair of injection holes are spaced from each other in an axial direction of the nozzle body, and such that injection axes of each pair of injection holes intersect with each other at a point outside of the nozzle body. In the fuel injector nozzle of the invention, jets of fuel ejected from each pair of injection holes collide with each other immediately after passing through exits or openings of the injection holes, such that a crossed axes angle θ formed by the injection axes of each pair of injection holes is in a range of 30°≦θ≦80°. By controlling the crossed axes angle θ to within this range, the spray penetration is reduced, and the fuel is uniformly and widely dispersed in the combustion chamber of the engine, while atomization of the fuel is encouraged to provide a reduced particle size. Consequently, the fuel can be mixed well with the air in the combustion chamber with improved efficiency, and the resulting air-fuel mixture is burned in a desirable manner, thus assuring excellent exhaust-gas characteristics.

To accomplish the second object, the present invention provides a fuel injector nozzle including an injector nozzle body having a distal end portion in which a plurality of pairs of injection holes are formed, such that each pair of injection holes are spaced from each other in an axial direction of the nozzle body, and such that injection axes of each pair of injection holes intersect with each other at a point outside of the nozzle body. In this fuel injector nozzle, jets of fuel ejected from each pair of injection holes collide with each other immediately after passing through exits or openings of the injection holes, during a period of time between an initial period of a suction stroke of a piston of an engine and an intermediate period of a compression stroke of the piston, such that a crossed axes angle θ formed by the injection axes of each pair of injection holes is in a range of 30°≦θ≦80° By controlling the crossed axes angle to within this range, the spray penetration is reduced, and the fuel is uniformly and widely dispersed in the combustion chamber of the engine, while atomization of the fuel is encouraged to provide a reduced particle size. Thus, the fuel injector nozzle is able to produce fuel spray suitable for compression-ignition type premixed combustion, and the fuel can be mixed well with the air in the combustion chamber with improved efficiency,

In one preferred form of the invention as described just above, a cavity is formed in a middle portion of the piston, such that the cavity has a size large enough to receive fuel sprays resulting from collision of jets of fuel emitted from the injection holes. In addition to the advantages as described above, prelimnary mixing of the fuel with the air can be accomplished during the compression stroke of the piston, or lifting process of the piston, thus enabling favorable compression-ignition premixed combustion.

### BRIEF DESCRIPTION OF THE DRAWINGS

The invention will be described in greater detail with reference to certain preferred embodiments thereof and the accompanying drawings, wherein:

FIG. 1A is a view showing the structure of a principal part of a fuel injector nozzle according to the first embodiment of the present invention, and FIG. 1B is a view showing the form of fuel sprays ejected from the fuel injector nozzle;

FIG. 2 is a graph showing the relationships between the crossed axes angle θ of injection axes of each pair of injection holes (collision angle of fuel jets ejected from the holes), and the spray penetration and the spray angle, respectively;

FIG. 3 is a graph showing the relationship between the crossed axes angle θ of injection axes of each pair of injection holes (collision angle of fuel jets ejected from the holes), and the particle size of the resulting fuel spray;

FIG. 4 is a view showing the structure of a principal part of a fuel injector nozzle according to the second embodiment of the present invention;

FIG. 5 is a view showing the structure of a principal part of a fuel injector nozzle according to the third embodiment of the present invention;

FIG. 6 is a view showing the structure of a principal part of a fuel injector nozzle according to the fourth embodiment of the present invention; and

FIG. 7A through FIG. 7H are views useful in explaining dispersion of fuel sprays in relation to the crossed axes angle θ of injection axes of each pair of injection holes (collision angle of fuel jets ejected from the holes).

### DETAILED DESCRIPTION OF THE PREFERRED EMBODIMENTS

Some embodiments of the present invention will be described with reference to the drawings.

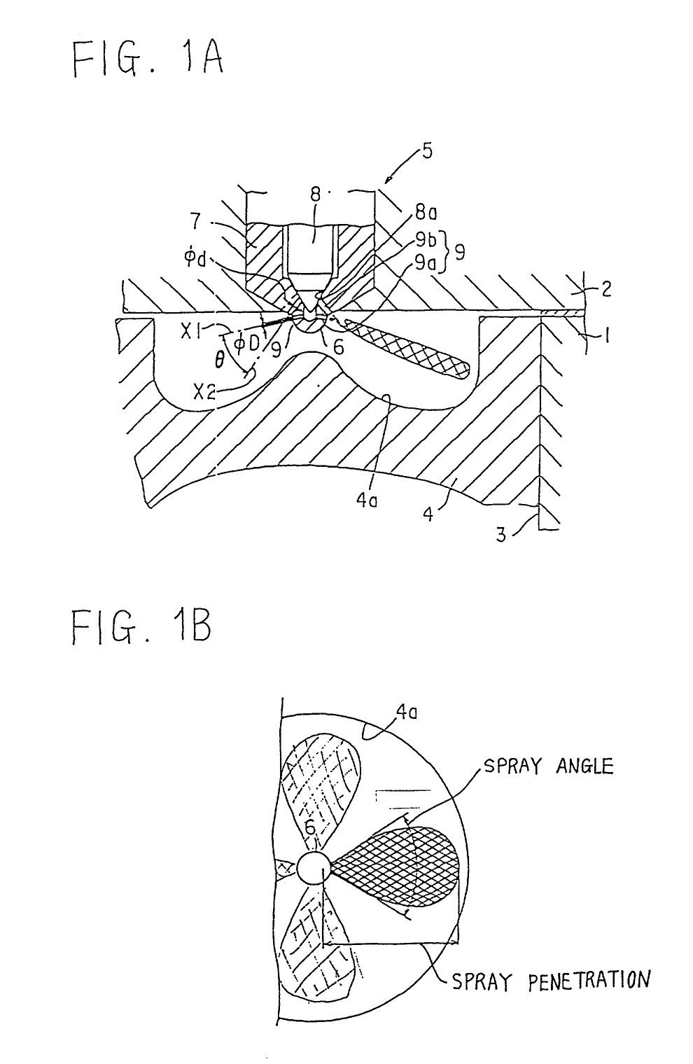

Referring first to FIG. 1 through FIG. 3, a fuel injector nozzle according to the first embodiment of the present invention will be described in detail.

FIG. 1 shows the vicinity of a combustion chamber of an internal combustion engine, such as a diesel engine, including the fuel injector nozzle of the present invention. In FIG. 1, a cylinder head 2 is mounted on the upper face of a cylinder block 1. A piston 4 is fitted in a cylinder bore 3 formed in the cylinder block 1 such that the piston 4 can reciprocate along the cylinder bore 3. A cavity or recess 4a is formed in an upper, central portion of the piston 4.

A fuel injector nozzle 5 is installed in a portion of the cylinder head 2 that corresponds to each cylinder of the engine, to be located at a substantially central portion of the cavity 4a. A fuel supply system (not shown), such as a fuel injection pump or accumulator, is adapted to supply fuel to the fuel injector nozzle 5.

The fuel injector nozzle 5 includes a nozzle body 7 that is formed with a nozzle sac 6 (or sac volume of a nozzle tip) at its distal end, and a needle valve X that is received within the nozzle body 7 such that the valve 8 can reciprocate toward and away from the nozzle sac 6. The nozzle sac 6 of the nozzle body 7 protrudes from the lower surface of the cylinder head 2, into the cavity 4a defined by the piston 4. The nozzle sac 6 is formed with a plurality of injection parts 9 that are arranged in the circumferential direction. As the nozzle valve 8 is lifted up, high-pressure fuel supplied from the fuel supply system is injected toward the cavity 4a of the piston 4, through the respective injection parts 9.

A pair of injection holes 9a, 9b are formed through each of the injection parts 9 of the nozzle sac 6, such that the holes 9a, 9b are spaced from each other in the axial direction of the nozzle body 7. The injection holes 9a, 9b extend obliquely toward the cavity 4a, or downwards, and the injection axes X1, X2 of the injection holes 9a, 9b cross each other on the outside of the nozzle body 7. More specifically, the injection hole 9a is formed through the outer circumferential portion of the nozzle sac 6 in the vicinity of the boundary between the nozzle sac 6 and the nozzle body 7, such that the hole 9a extends from the inner bore of the nozzle body 7 toward the cavity 4a, while being slightly inclined with respect to the plane perpendicular to the axis of the nozzle body 7. The injection hole 9b is formed through a valve seat 8a for receiving the needle valve 8, in the vicinity of the above boundary, such that the hole 9b extends obliquely from the inner bore of the nozzle body 7 toward the cavity 4a, to form an acute angle with respect to the plane perpendicular to the axis of the nozzle body 7. By suitably controlling the directions of the pair of injection holes 9a, 9b, two jets of fuel ejected from the holes 9a, 9b are adapted to collide with each other at a location (the intersection of the injection axes X1, X2) immediately outside of exits or outlets of the holes.

The angle (crossed axes angle) θ formed by the injection axes X1, X2 of the injection holes 9a, 9b, namely, angle (collision angle) θ at which two jets of fuel ejected from each pair of injection holes 9a, 9b collide with each other on the outside of the nozzle body 7, is controlled to a suitable value in the range of 30°≦θ≦80°, so that favorable fuel spray or mist can be formed.

A jet of fuel that results from collision of two jets of fuel at the intersection of the axes X1, X2 of each pair of injection holes 9a, 9b has a generally flat shape as viewed in the vertical direction and expands or spreads over a horizontal plane to provide a certain distribution of fuel concentration, as shown in FIG. 1A and FIG. 1B. The manner in which the fuel jet or spray spreads determines the spray penetration, degree of atomization of the spray, and the degree of expansion of the spray (spray angle).

The present inventors conducted certain experiments so as to find the relationship between the collision angle θ and the spray penetration, spray angle, and the particle size of the fuel spray. FIG. 2 shows the results of the experiments in terms of the spray penetration and the spray angle (as indicated in FIG. 1B).

When the collision angle θ was equal to or smaller than 20°, the fuel spray had a strong tendency of being directed toward a cylinder liner wall (i.e., in the radial direction of the cylinder), and therefore the spray penetration, or distance of extension of the spray, was excessively increased. As a result, the fuel was likely to adhere to the cylinder liner wall. When the collision angle θ was around 30°, the resulting fuel spray showed substantially the same spray penetration as that produced by a conventional nozzle. When the collision angle θ was 30° or larger, the force of the spray directed toward the cylinder liner waft (i.e., in the radial direction of the cylinder) was reduced as the collision angle θ increased, namely, the spray penetration was inversely proportional to the collision angle θ.

The spray angle had a tendency of increasing as the spray penetration was reduced with an increase in the collision angle θ. In fact, the spray angle was equivalent to that of the conventional nozzle when the collision angle θ was 20° or smaller, and increased in proportion to the collision angle θ once the collision angle θ exceeded 20°.

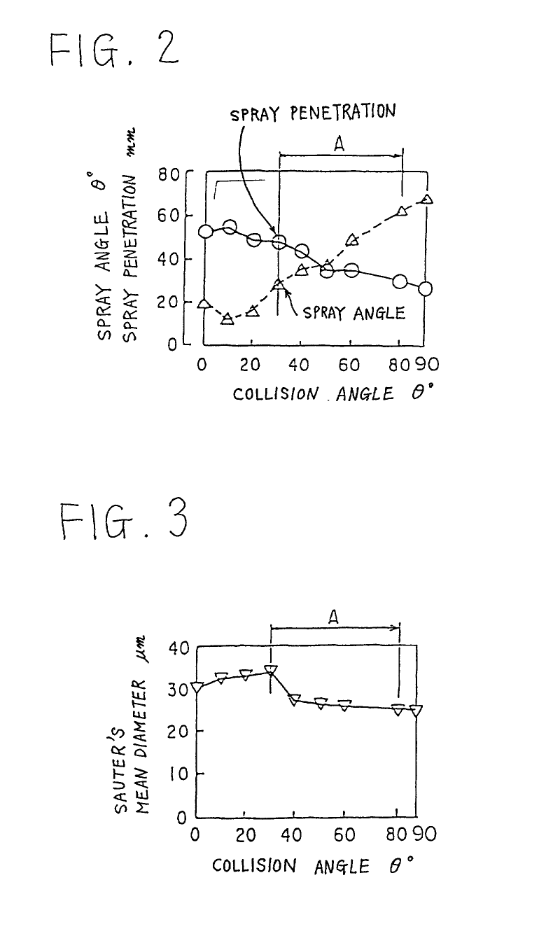

The particle size of the fuel spray was equivalent to that of the conventional nozzle when the collision angle θ was equal to or smaller than 30°, and it was reduced by degrees when the collision angle θ exceeded 30°, as shown in FIG. 3. Further, it was reduced by approximately 10% when the collision angle θ was equal to or bigger than 40°.

In the meantime, the fuel injector nozzle 5 is provided with a plurality of pairs of injection holes 9a, 9b that are arranged in the circumferential direction of the nozzle, so that the possibly largest amount of the fuel can be injected into the cavity 4a within a short time. In operation, a fuel spray resulting from collision of two jets of fuel ejected from each pair of injection holes 9a, 9b should be dispersed and mixed with other fuel sprays resulting from collision of fuel jets from adjacent pairs of injections holes, while involving the air surrounding the fuel sprays. To this end, a layer of the air, or air film, is desired to be present between the sprays ejected from the adjacent pairs of the injection holes 9a, 9b, so as to accomplish desired dispersion and mixture of these fuel sprays.

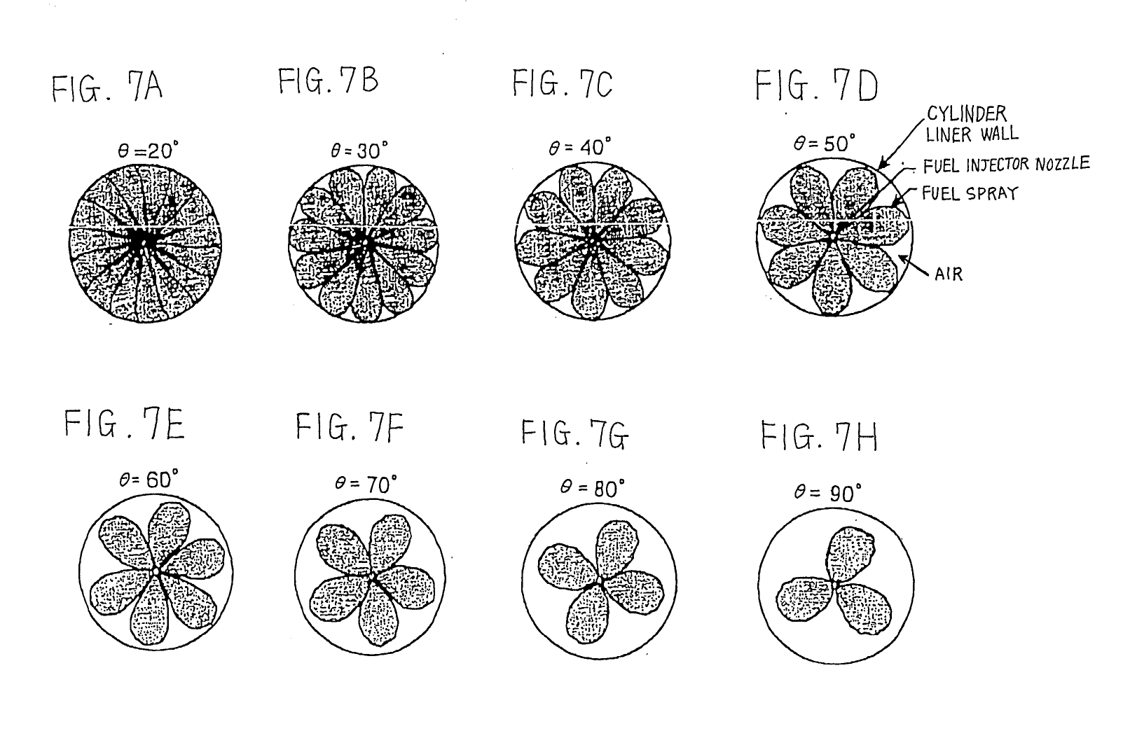

FIG. 7A through FIG. 7H show the relationships between the magnitude of the collision angle θ and the presence of the air layer, which are determined using the spray angle. If the collision angle θ is 20° or smaller, a large number of pairs of injection holes may be provided since the spray angle is small, but the spray tends to adhere to the cylinder liner wall (or cavity wall) and fails to be mixed with the air. If the collision angle θ is in the range of 30° to 80°, a suitable air layer is present between sprays ejected from adjacent pairs of injection holes, while allowing formation of the equal or larger number of injection holes as compared with those of a conventional nozzle. If the collision angle θ exceeds 80°, the amount of the air tends to be excessively large compared to that of the fuel. In FIG. 7, the interference between the fuel sprays and the number of the injection holes are determined under a condition that geometric shapes or areas of the sprays calculated from the spray angle do not overlap with each other in the circumferential direction.

As is understood from the above description the upper limit of the collision angle θ is set to 80° so that a suitable amount of the air is present between fuel sprays ejected from adjacent pairs of the injection holes.

It follows from the above description that the collision angle θ is set to within the range of 30°≦θ≦80° (the range denoted by A in FIG. 2), so as to satisfy three requirements or demands, namely, reduction in the spray penetration, reduction in the particle size of the fuel spray, and uniform fuel dispersion that can be achieved by eliminating variations in the concentration of the fuel. In particular, the collision angle θ is most preferably set to 60°.

With the collision angle θ controlled to the above range, the fuel injector nozzle 5 of the present embodiment is able to produce fuel sprays having sufficiently small spray penetration and significantly reduced particle size, such that the fuel can be uniformly and widely dispersed. Thus, the fuel sprays produced by the present fuel injector nozzle 5 are prevented from adhering to the walls of the combustion chamber (including the lower surface of the cylinder head 2), and thus mixed well with the air in the combustion chamber with high efficiency, to provide a favorable air/fuel mixture to be burned in the chamber.

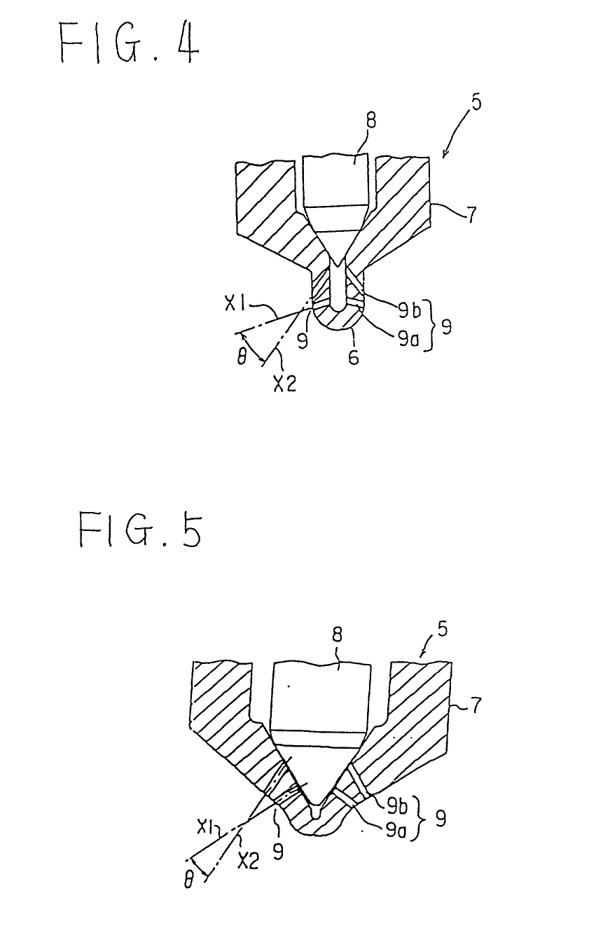

In the embodiment as illustrated above, the injection holes 9a, 9b are formed through the nozzle sac 6 and the valve seat 8, respectively. In the second embodiment as shown in FIG. 4, both of the injection holes 9a, 9b are formed through the nozzle sac 6. In this case too, the fuel injector nozzle 5 yields the same effects as provided in the first embodiment.

In the third embodiment as shown in FIG. 5, both of the injection holes 9a, 9b are formed through the valve seat 8. In this case, too, the fuel injector nozzle 5 yields the same effects as provided in the first embodiment. In FIG. 5, the same reference numerals as used in FIG. 1 are used for identifying corresponding components.

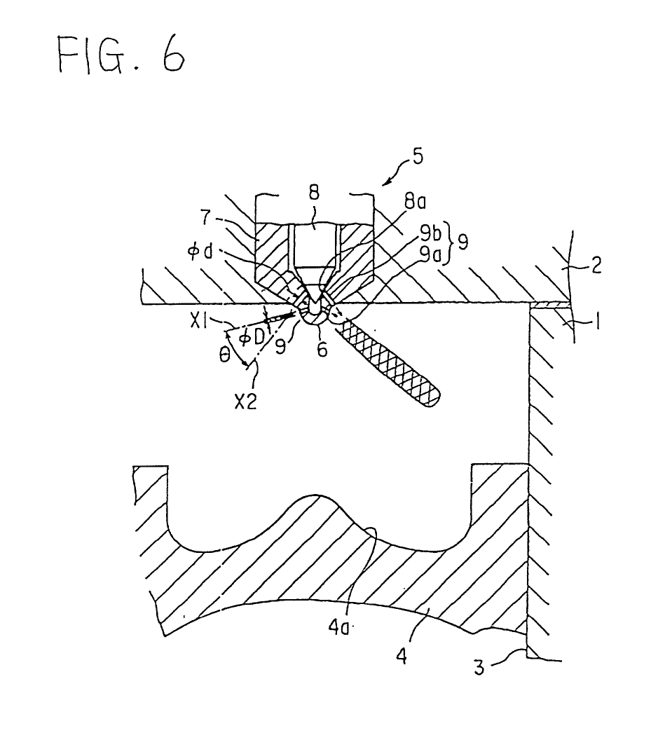

A fuel injector nozzle according to the fourth embodiment of the present invention will be now described with reference to FIG. 6.

In the present embodiment, the crossed axes angle θ formed by injection axes X1, X2 of each pair of injection holes 9a, 9b, namely, collision angle θ at which two jets of fuel ejected from the injection holes 9a, 9b collide with each other on the outside of the nozzle body 7, is set to within the range of 30°≦θ≦80°, so that the fuel injector nozzle can emit fuel sprays suitable for compression-ignition premixed combustion as described below.

So-called compression-ignition premixed combustion is known as a method of realizing lean burn or combustion of a fuel-lean air/fuel mixture. In this combustion method, fuel is injected into the cylinder during an early period of combustion cycle (namely, between the initial period of the suction stroke and the intermediate period of the compression stroke), so that the fuel is well mixed with the air over a certain length of time, so as to form a uniform fuel-lean air/fuel mixture in the entire volume of the cylinder, for subsequent combustion. For example, the fuel is injected into the cylinder in the initial period of the compression stroke, and then mixed with the air during the compression stroke, so that the premixed mixture ignites by itself at the end of the compression stroke.

To favorably accomplish the combustion with the lean mixture, it is desirable to prevent the fuel from adhering to the lower surface of the cylinder block 2, and to produce fuel sprays having reduced spray penetration, which are directed toward the piston 4 spaced apart from its top dead end while its atomization is being accelerated, namely, its particle size is being reduced.

In addition to the above points, it is also desired in the compression-ignition type premixed combustion to inject a large amount of fuel within a short time, so as to ensure a sufficient amount of premixed air/fuel mixture, namely, to inject the desired amount of fuel in a short time so as to accomplish mixing of the fuel with the air, without allowing the fuel to adhere to the cylinder liner wall. If the fuel injector nozzle cannot produce fuel sprays to meet with these requirements, it is impossible to carry out favorable premixed combustion within the cylinder.

In the fuel injector nozzle 5 of the present embodiment, therefore, each pair of injection holes 9a, 9b are formed to extend obliquely towards the cavity 4a of the piston 4, or downwards, such that the injection axes X1, X2 of these holes intersect with each other on the outside of the nozzle body 7, so as to provide fuel sprays directed toward the upper face of the piston 4 in the initial period of the compression stroke, namely, to inject the fuel closer to the center of the piston 4 as compared with the first embodiment. The angle (crossed axes angle) θ at which the injection axes X1, X2 intersect with each other on the outside of the nozzle body 7, namely, collision angle θ at which two jets of fuel emitted from the injection holes 9a, 9b collide with each other outside of the nozzle body 7, is set to within the range of 30°≦θ≦80°, as in the first embodiment. With the collision angle thus controlled, the resultant fuel sprays exhibit desired characteristics, and the fuel injector nozzle provides desired injection characteristics.

Setting of the collision angle θ to within the above-indicated range is advantageous in the compression-ignition type premixed combustion, because the desired amount of fuel can be injected in a short time, without allowing the fuel to adhere to the liner wall, so that mixing of the fuel with the air can be completed in a short time. Thus, the fuel injection nozzle of the present embodiment achieves desired characteristics, namely, a high rate of injection, high degree of dispersion, and improved atomization (or reduced particle size) of fuel spray.

Here, the high rate of injection means that a large amount of fuel can be injected within a short time. More specifically, the rate of injection is increase with an increase in the total area of injection holes, or an increase in the number of pairs of injection holes if the same size of holes are provided.

The high degree of fuel dispersion means that the fuel expands or spreads uniformly while being widely dispersed, to be mixed well with the air. To achieve a high degree of fuel dispersion, a sufficiently large spray angle is provided, while ensuring that a fuel spray from each pair of injection holes does not interfere with a fuel spray from another pair of holes. More specifically, the degree of fuel dispersion is increased with an increase in the number of injection holes, and also with an increase in the total area of the injection holes.

The following was derived from consideration on desired characteristics in terms of adhesion of the fuel to the wall, rate of fuel injection, dispersion and mixing of fuel spray, and atomization, in view of the above points.

The adhesion of the fuel to the wall of the combustion chamber may be judged from changes in the fuel spray penetration with varying collision angle θ as shown in FIG. 2. Namely, if the collision angle θ is 20° or smaller, the fuel spray has a strong tendency of being directed toward the cylinder liner wall (i.e., in the radial direction of the cylinder), or the spray penetration tends to be large, and therefore the fuel spray is likely to adhere to the cylinder liner wall. If the collision angle θ is around 30°, the fuel injector nozzle shows substantially the same spray penetration as a conventional fuel injector nozzle. If the collision angle θ exceeds 30°, the force directed toward the liner wall (in the radial direction of the cylinder) is reduced with an increase in the collision angle θ, namely, the spray penetration is inversely proportional to the collision angle θ.

The relationship of the collision angle θ with the rate of fuel injection will be understood from dispersion of fuel sprays as indicated in FIG. 7A through FIG. 7H.

In order to increase the amount of injection per unit time, the number of pairs of injection holes may be increased while reducing the collision angle θ, as far as adjacent fuel sprays do not interfere with each other. If fifteen pairs of injection holes are provided with the collision angle θ being 20° or smaller, however, the spray penetration is excessively large, resulting in adhesion of the fuel to the cylinder liner wall. If the number of pairs of injection holes is in the range of 11 to 6 with the collision angle θ being in the range of 30° to 60°, the number of injection holes is balanced by the spray penetration. The number of pairs of injection holes reaches its lower limit when the collision angle θ is 80°.

The interference between fuel sprays and the number of pairs of injection holes in FIG. 7A-H are determined under a condition that geometric shapes or areas of the sprays calculated from the spray angle do not overlap with each other in the circumferential direction.

The dispersion/mixing of fuel spray will also be understood from FIG. 7A through FIG. 7H. Namely, it is desirable that a fuel spray resulting from collision of fuel jets from each pair of injection holes is mixed with other fuel sprays from adjacent pairs of injection holes, while involving the air surrounding the fuel sprays, so that the resulting air/fuel mixture spreads uniformly within the cylinder.

To ensure favorable dispersion/mixing, an air layer or film is required to be present between fuel sprays resulting from collision of fuel jets from adjacent pairs of injection holes, so that these fuel sprays can be dispersed and mixed together.

As is understood from FIG. 7A through FIG. 7H, if the collision angle θ is 30° or smaller, some portions of the fuel sprays adhere to the liner wall, and fail to be mixed with the air, which is disadvantageous in terms of mixing of the fuel with the air. When the number of pairs of injection holes is in the range of 6 to 11 with the injection angle θ being in the range of above 30° to 60°, a suitable amount of the air is present between adjacent sprays as a result of collision. When the collision angle θ is 80°, the number of pairs of injection holes (four) reaches its lower limit that barely allows mixing of the fuel with the air. If the collision angle θ exceeds 80°, the amount of the air is excessively large, making it difficult to produce a uniform air/fuel mixture.

With regard to the degree of atomization, it will be understood from FIG. 3 showing changes in the particle size with the collision angle θ that, if the collision angle is 30° or smaller, the particle size is equivalent to that of fuel spray emitted by a conventional fuel injector nozzle, as described above with respect to the first embodiment. If the collision angle θ exceeds 30°, the particle size is reduced by about 10%, and fine particles are provided.

TABLE 1 below shows the results of judgment as to whether fuel sprays emitted from a conventional fuel injector nozzle and the fuel injector nozzles of the present invention are suited for compression-ignition type premixed combustion, in view of the above characteristics and changes in the spray angle with the collision angle θ as shown in FIG. 3. In TABLE 1, “A” represents the highest level, “B” represents a relatively high level “C” represents a satisfactory level, and D represents a level below a required level.

TABLE 1

| | Conventional | Collision Angle (θ) | | | | | | |
|---|---|---|---|---|---|---|---|---|
| | nozzle | 20° | 30° | 40° | 50° | 60° | 80° | 90° |
| Adhesion to | D | D | C | B | B | A | A | A |
| wall | | | | | | | | |
| Rate of | A | A | A | A | A | A | B | D |
| injection | | | | | | | | |
| Dispersion/ | D | D | C | B | B | A | C | D |
| Particle size | D | D | D | B | B | B | B | B |
| Total | D | D | C | B | B | A | B | D |

Judging from the above results, it was found that the fuel injector nozzle is able to produce desirable fuel sprays and exhibit suitable injection characteristics for compression-ignition type premixed combustion, if the collision angle θ at which jets of fuel ejected from each pair of injection holes 9a, 9b collide with each other is in the range of 30°≦θ≦80°.

In addition, when the collision angle θ is in the range of 40°≦θ≦80°, the above characteristics are better than those in the range of 30°≦θ≦80°. In particular, when the collision angle θ is 60°, all of the above characteristics are far better than those in the case with the other collision angles.

Further, the size (and shape) of the cavity 4a formed in a central portion of the upper face of the piston 4 is set to be large enough to receive the fuel sprayed from the fuel injector nozzle, as shown in FIG. 6. Accordingly, the fuel is well mixed with the air prior to combustion during the compression stroke or lifting process of the piston 4, thus assuring even more desirable compression-ignition type premixed combustion.

It is to be noted that in FIG. 6, the same reference numerals as used in the first embodiment of FIG. 1 are used for identifying corresponding components.

What is claimed is:

1. A fuel injector nozzle comprising:
an injector nozzle body having a distal end portion in which a plurality of pairs of injection holes are formed such that each pair of injection holes are spaced from each other in an axial direction of the injector nozzle body, and such that injection axes of said each pair of injection holes intersect with each other at a point outside of said nozzle body,
wherein jets of fuel ejected from said each pair of injection holes collide with each other immediately after passing through exits of the injection holes, such that a crossed axes angle θ formed by the injection axes of said each pair of injection holes is in a range of 30°≦θ≦80°.

2. A fuel injector nozzle according to claim 1, wherein said crossed axes angle θ formed by the injection axes of said each pair of injection holes is in a range of 40°≦θ≦80°.

3. A fuel injector nozzle according to claim 1, wherein said crossed axes angle θ formed by the injection axes of said each pair of injection holes is set to 60°.

4. A fuel injector nozzle comprising:
an injector nozzle body having a distal end portion in which a plurality of pairs of injection holes are formed such that each pair of injection holes are spaced from each other in an axial direction of the injector nozzle body, and such that injection axes of said each pair of injection holes intersect with each other at a point outside of said nozzle body,
wherein jets of fuel ejected from said each pair of injection holes collide with each other immediately after passing through exits of the injection holes, during a period of time between an initial period of a suction stroke of a piston of an engine and an intermediate period of a compression stroke of the piston, such that a crossed axes angle θ formed by the injection axes of said each pair of injection holes is in a range of 30°≦θ≦80°.

5. A fuel injector nozzle according to claim 4, wherein a cavity is formed in a middle portion of said piston, said cavity having a size large enough to receive a fuel spray resulting from collision of the jets of fuel ejected from said each pair of injection holes.

6. A fuel injector nozzle according to claim 4, wherein said crossed axes angle θ formed by the injection axes of said each pair of injection holes is in a range of 40°≦θ≦80°.

7. A fuel injector nozzle according to claim 4, wherein said crossed axes angle θ formed by the injection axes of said each pair of injection holes is set to 60°.
